(19) United States
(12) Patent Application Publication
(10) Pub. No.: US 2015/0357786 A1
(43) Pub. Date: Dec. 10, 2015

(54) LIGHT SOURCE APPARATUS AND INFORMATION ACQUISITION APPARATUS USING THE SAME

(71) Applicant: CANON KABUSHIKI KAISHA, Tokyo (JP)

(72) Inventors: Yukihiro Inoue, Tucson, AZ (US); Hideo Iwase, Kawasaki-shi (JP)

(21) Appl. No.: 14/727,441

(22) Filed: Jun. 1, 2015

(30) Foreign Application Priority Data
Jun. 6, 2014 (JP) 2014-118104

(51) Int. Cl. H01S 3/067; H01S 3/108; G01N 21/63; H01S 3/08; G01N 21/55; G01N 21/59; H01S 3/11; H01S 3/094

(52) U.S. Cl. CPC H01S 3/06754; H01S 3/1106; H01S 3/108; H01S 3/06745; H01S 3/094003; H01S 3/094076; H01S 3/08013; G01N 21/55; G01N 21/59; G01N 21/63; G01N 2201/06113

(57) ABSTRACT

A light source apparatus, which emits pulsed light, includes: a light source that emits first pulsed light; a first nonlinear optical medium that generates a first optical parametric gain upon incidence of the first pulsed light; and a second nonlinear optical medium that generates a second optical parametric gain different from the first optical parametric gain upon incidence of the first pulsed light. The first nonlinear optical medium and the second nonlinear optical medium are arranged in series and both have normal dispersion characteristics in the center wavelength of the first pulsed light. A zero dispersion wavelength of the first nonlinear optical medium differs from a zero dispersion wavelength of the second nonlinear optical medium.

### BACKGROUND OF THE INVENTION

### 1. Field of the Invention

The present invention relates to a pulsed light source with a variable center wavelength, and relates also to an information acquisition apparatus using the pulsed light source.

### 2. Description of the Related Art

Various types of information about substances that constitute a subject may be obtained by irradiating the subject with pulsed light and detecting any of light reflected or scattered on the subject, light passing through the subject, or fluorescence emitted from the subject. Studies to identify substances of a subject in the following manner have been routinely carried out in recent years: a subject is irradiated with two types of pulsed light having a frequency difference corresponding to the number of molecular vibrational frequency, and light based on stimulated Raman scattering (SRS) and coherent Anti-Stokes Raman scattering (CARS) produced from the subject are detected using appropriate light detectors. The information about the subject or about substances that constitute the subject is extracted using image processing algorithms. In these measuring methods, a light source apparatus that emits pulsed light of a narrow spectral line width and large peak intensity is desired to obtain information with a high signal-to-noise (S/N) ratio.

As a laser light source that generates two types of pulsed light with different center wavelengths, a fiber optical parametric amplifier (FOPA) using four wave mixing (a kind of optical parametric effect) produced in optical fiber is known. In four wave mixing, when energy of excitation pulsed light incident on the optical fiber is received, the FOPA generates light of which wavelength is different from that of excitation pulsed light.

Baumgartl, M. et al., “Alignment-free, all-spliced fiber laser source for CARS microscopy based on four-wave-mixing”, Optics Express Vol. 20, No. 19, pp. 21010-21018, Sep. 10, 2012 discloses a method for imaging by irradiating a subject with two types of pulsed light with different wavelengths, and detecting light based on the CARS using a light source apparatus that emits excitation pulsed light to be incident on the FOPA and generated light generated in the FOPA.

An FOPA formed by one kind of optical fiber is used in the light source apparatus disclosed in Optics Express Vol. 20, No. 19, pp. 21010-21018, Sep. 10, 2012. In this configuration, the peak intensity and the spectral line width are in a trade-off relationship in which the spectral line width becomes large when the peak intensity of emitted pulsed light is to be increased.

When the peak intensity of the pulsed light with which the subject is irradiated is low, light based on the SRS or the CARS becomes weak, and a powerful signal is no longer be obtained. Therefore, the S/N ratio is reduced. When the spectral line width of the pulsed light with which the subject is irradiated is large, in the measurement of the subject constituted by a certain substance, a frequency difference component inconsistent with a molecular vibrational frequency of the substance to be measured is included in a frequency difference of the two types of pulsed light. Therefore, noise due to a frequency difference component inconsistent with the molecular vibrational frequency is included in the Raman spectrum obtained from the subject, and the S/N ratio is reduced.

### SUMMARY OF THE INVENTION

A light source apparatus according to the present invention includes: a light source configured to emit first pulsed light; a first nonlinear optical medium configured to generate a first optical parametric gain upon incidence of the first pulsed light; and a second nonlinear optical medium configured to generate a second optical parametric gain different from the first optical parametric gain upon incidence of the first pulsed light, wherein the first nonlinear optical medium and the second nonlinear optical medium have normal dispersion characteristics in the center wavelength of the first pulsed light, a zero dispersion wavelength of the first nonlinear optical medium is different from that of the second nonlinear optical medium, and the first nonlinear optical medium and the second nonlinear optical medium are arranged in series.

Further features of the present invention will become apparent from the following description of exemplary embodiments with reference to the attached drawings.

### BRIEF DESCRIPTION OF THE DRAWINGS

FIG. 1 is a schematic diagram illustrating a light source apparatus according to a first embodiment of the present invention.

FIG. 2 is a schematic diagram illustrating a light source apparatus according to a second embodiment of the present invention.

FIG. 3 is a schematic diagram illustrating an information acquisition apparatus according to a third embodiment of the present invention.

FIG. 4 is a schematic diagram illustrating an optical parametric gain proposed by the present invention.

FIGS. 5A and 5B are graphs illustrating phase mismatching Δβ in an optical propagation constant and an optical parametric gain G in a nonlinear optical medium when β₂>0 and β₄≧0.

FIGS. 6A and 6B are graphs illustrating phase mismatching Δβ of an optical propagation constant and an optical parametric gain G in a nonlinear optical medium when β₂>0 and β₄<0.

FIGS. 7A and 7B are graphs illustrating phase mismatching Δβ of an optical propagation constant and an optical parametric gain G in a nonlinear optical medium when β₂≦0 and β₄≧0.

FIGS. 8A and 8B are graphs illustrating phase mismatching Δβ of an optical propagation constant and an optical parametric gain G in a nonlinear optical medium when β₂≦0 and β₄<0.

FIG. 9 illustrates a light source apparatus disclosed in Optics Express Vol. 20, No. 19, pp. 21010-21018, Sep. 10, 2012.

### DESCRIPTION OF THE EMBODIMENTS

A light source apparatus according to the present invention has a light source that emits excitation pulsed light with variable center wavelength, and a plurality of nonlinear optical media that generate generated light. Each of a plurality of nonlinear optical media has normal dispersion characteristics, and has a mutually different zero dispersion wavelength. As a nonlinear optical medium that satisfies these conditions, optical fiber may be used suitably. In the present invention, the center wavelength refers to the wavelength at which the peak intensity of the pulsed light spectrum becomes the highest or maximum.

Before beginning detailed description about the present invention, a phenomenon that generated light is generated from excitation pulsed light, i.e., a principle of generation of four wave mixing that produces an optical parametric gain is described. Four wave mixing is one of the parametric effects, and is a phenomenon that, when two types of excitation light having different center wavelengths are made to enter into a nonlinear optical medium, such as fiber, light having a center wavelength inconsistent with any wavelengths of these types of light is newly generated. At this time, a part of energy of the excitation light incident on the nonlinear optical medium is converted into energy of light that is newly generated by four wave mixing. For example, when two types of excitation light of which frequencies (i.e., inverses of the center wavelength) are ω₁ and ω₂ are made to enter into the nonlinear optical medium, two types of generated light of which frequencies are ω₃ and ω₄, are newly generated, and the relationship of ω₁+ω₂=ω₃+ω₄ is satisfied.

When there is one frequency of excitation light, i.e., ω₁=ω₂=ω_{c}, such a case is referred to as degeneration four wave mixing; in which two types of generated light of which frequency is ω_{c}+Δω and ω_{c}−Δω, respectively, are generated symmetrically about a center frequency ω_{c}. Generally, a high frequency (center wavelength is short) side is referred to as signal light, and a low frequency (center wavelength is long) side is referred to as idler light. In this specification, the signal light and the idler light are referred to as generated light when it is not necessary to distinguish between signal and idler light. Hereinafter, a frequency of the signal light is expressed by ωₛ(=ω_{c}+Δω) and a frequency of the idler light is expressed by ωᵢ(=ω_{c}−Δω).

Degeneration four wave mixing is simple in control and in system configuration of the wavelength compared with a case in which two types of light with different frequencies are made to enter. Therefore, degeneration four wave mixing is broadly used for a light source apparatus of an information acquisition apparatus. Thus, a light source apparatus in which degeneration four wave mixing is used is described in the present application.

In order to generate degeneration four wave mixing efficiently, it is necessary to satisfy phase matching conditions expressed by the following Expression (1) if a propagation constant of excitation light in the nonlinear optical medium is denoted by β_{c}, a propagation constant of the signal light is denoted by βₛ, and a propagation constant of the idler light is denoted by βᵢ:

$$- 4 γ {P}_{c} < Δβ = {β}_{s} + {β}_{i} - 2 {β}_{c} < 0 γ = \frac{{ω}_{c}}{c} \frac{{n}_{2}}{{A}_{eff}} . \qquad Expression ( 1 )$$

In Expression (1), Δβ denotes phase mismatching of an optical propagation constant in the nonlinear optical medium, γ denotes a nonlinear coefficient of the nonlinear optical medium, P_{c} denotes the peak intensity of excitation light, i.e., the peak intensity of the center wavelength. In Expression (1), n₂ denotes a nonlinear index of refraction of the nonlinear optical medium, A_{cff} denotes an effective sectional area of a core of optical fiber that is the nonlinear optical medium, and c denotes a speed of light in vacuum.

Phase mismatching Δβ of the optical propagation constant in the nonlinear optical medium may be expressed by the following Expression (2) using a frequency difference Δω:

Δβ=β₂(Δω)²+β₄(Δω)⁴/12 Expression (2).

In Expression (2), β₂ denotes group velocity dispersion in a frequency of excitation light of the nonlinear optical medium, and β₄ is a secondary differential coefficient of the group velocity dispersion β₂. The group velocity dispersion β₂ is a secondary differential coefficient of the propagation constant β_{c} of excitation light.

Optical parametric gain G by four wave mixing at this time is expressed by the following Expression (3). L denotes a length of the nonlinear optical medium.

$$G = {\vert \frac{sin h ( \sqrt{1 - {( 1 + Δβ / 2 γ {P}_{c} )}^{2}} γ {P}_{c} L )}{\sqrt{1 - {( 1 + Δβ / 2 γ {P}_{c} )}^{2}}} \vert}^{2} \qquad Expression ( 3 )$$

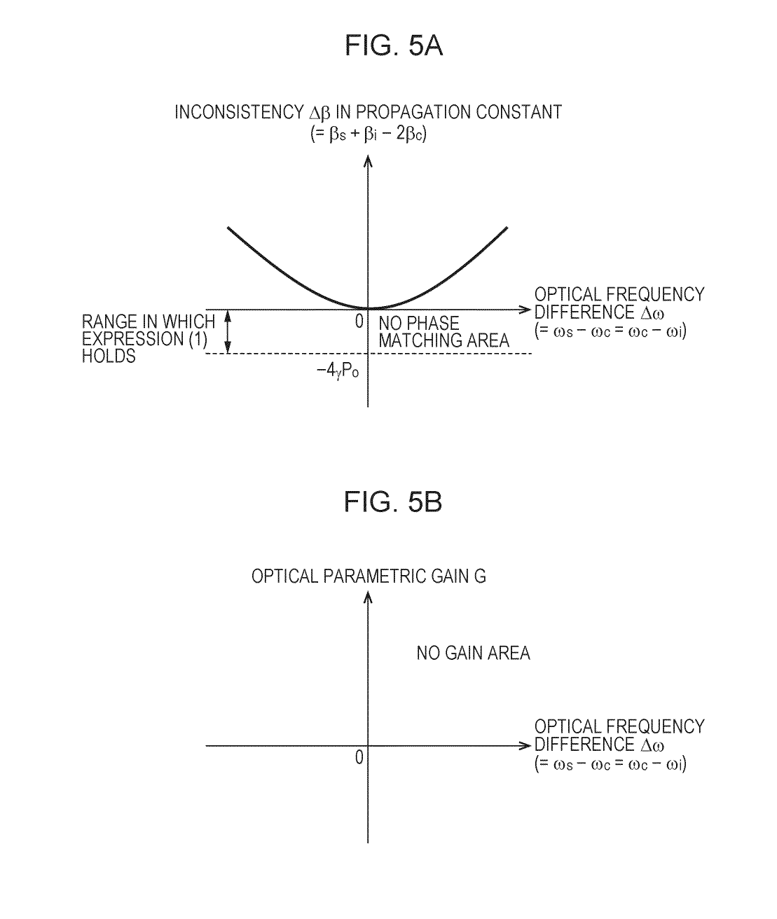

Next, regarding four nonlinear optical media in which β₂ is positive, or, negative or 0, and in which β₄ is positive or 0, or, negative, Expressions (2) and (3) are shown as graphs in FIGS. 5A to 8B. When β₂ of the nonlinear optical medium is positive, normal dispersion characteristics are shown and, when β₂ is negative, anomalous dispersion characteristics are shown.

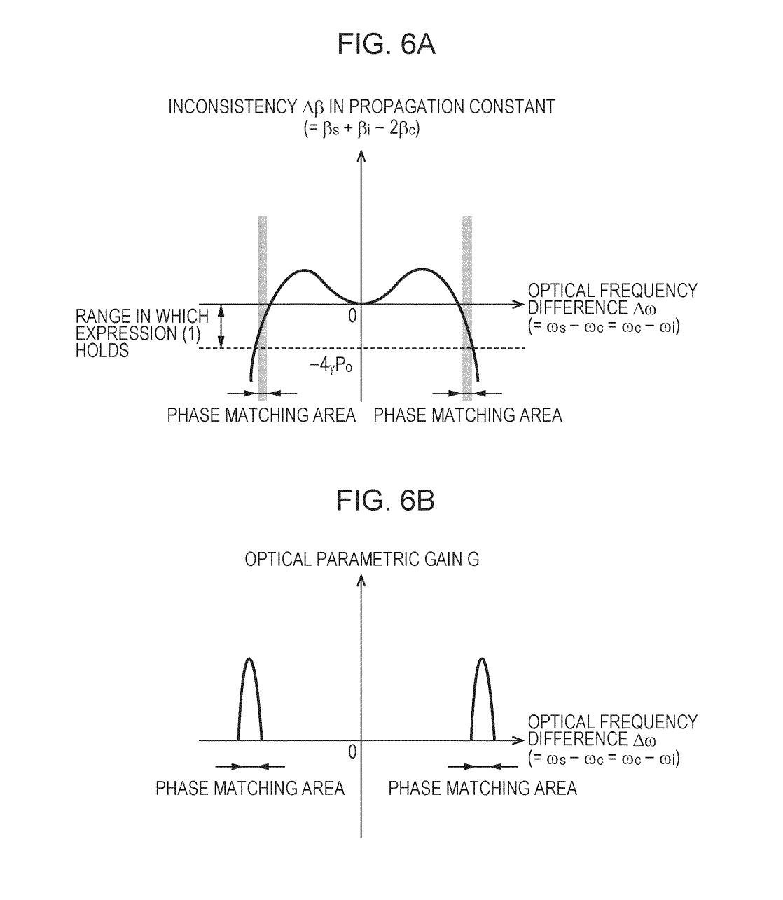

FIGS. 5A and 5B illustrate respectively the phase mismatching Δβ and the optical parametric gain G in a case of the nonlinear optical medium of β₂>0 and β₄≧0. FIG. 5A is a graph showing Expression (2), in which Δβ is plotted on the vertical axis and Δω is plotted on the horizontal axis. FIG. 5B is a graph showing Expression (3), in which G is plotted on the vertical axis and Δω is plotted on the horizontal axis. Each of graphs of FIGS. 6A, 7A and 8A is graph showing Expression (2) in different case, and each of graphs of FIGS. 6B, 7B and 8B is graph showing Expression (3) in different case.

Δβ must be a negative value to satisfy Expression (1), since both the nonlinear coefficient γ of the nonlinear optical medium and the peak intensity P_{c} of excitation light are positive values. However, when β₂>0 and β₄≧0, as illustrated in FIG. 5A, since Δβ takes a value equal to or greater than 0, no region satisfying Expression (1) that is a condition to efficiently generate the degeneration four wave mixing exists. That is, as illustrated in FIG. 5B, Δω at which the optical parametric gain G can be obtained does not exist. Therefore, if excitation pulsed light is made to enter into the nonlinear optical medium when β₂>0 and β₄≧0, neither signal light nor idler light is generated.

FIGS. 6A and 6B illustrate respectively the phase mismatching Δβ and the optical parametric gain G when β₂>0 and β₄<0. In the graph of FIG. 6A, hatched regions are where phase matching conditions of Δβ expressed by Expression (1) are established. The graph shows that the regions of Δω that satisfy the phase matching conditions expressed by Expression (1) exist at locations distant from the frequency of the excitation pulsed light and in relatively narrow ranges. Therefore, as illustrated in FIG. 6B, when excitation light of a certain frequency enters into the nonlinear optical medium, since the optical parametric gain G exists in a relatively narrow frequency band, signal light and idler light of narrow frequency bands are generated.

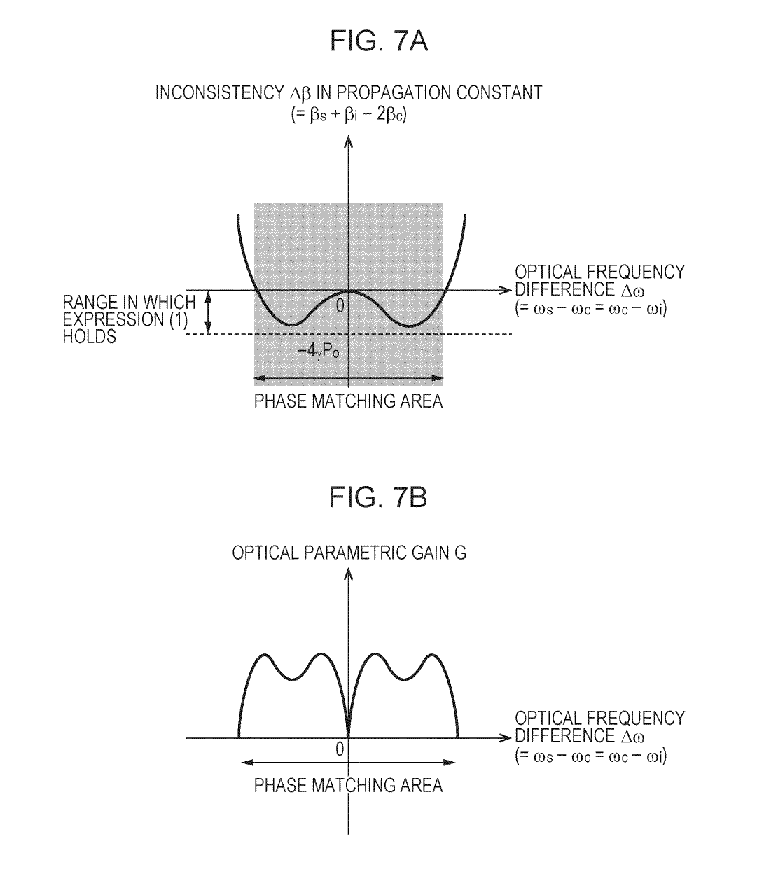

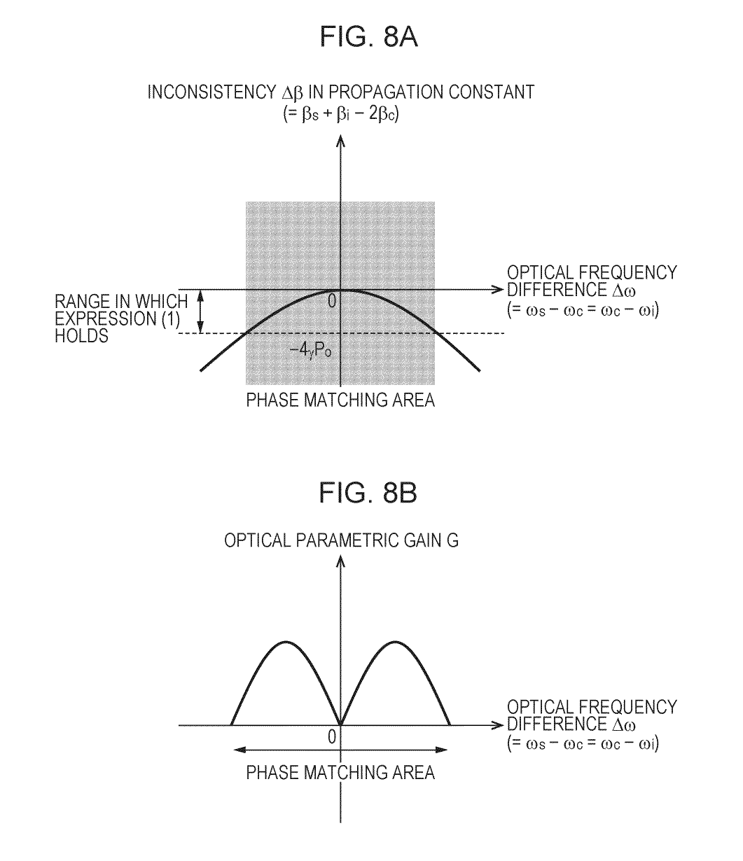

FIGS. 7A and 7B illustrate respectively the phase mismatching Δβ and the optical parametric gain G when β₂≦0 and β₄≧0 and FIGS. 8A and 8B illustrate about a nonlinear optical medium when β₂≦0 and β₄<0. FIGS. 7A and 8A show that, in the region of β₂≦0 (i.e., an anomalous dispersion region), a range of Δω that satisfies phase matching conditions expressed by Expression (1) (i.e., hatched range) expands continuously. That is, since an optical parametric gain G exists in a large frequency band, signal light and idler light of a wide frequency band are generated, and light of large frequency band illustrated in FIGS. 7B and 8B may be obtained.

As described above, to generate light of a narrow spectral width (i.e., narrowband light) using degeneration four wave mixing, it is desirable to use a nonlinear optical medium that satisfies β₂>0 and β₄<0. Further, to generate pulsed light of a wide spectral width (i.e., broadband light) using degeneration four wave mixing, it is desirable to use a nonlinear optical medium that satisfies β₂≦0. In the present invention, light of a narrow spectral width (i.e., narrowband light) refers to pulsed light of a spectral width equal to or narrower than 10 nm, and light of a wide spectral width (i.e., broadband light) refers to pulsed light of a spectral width equal to or greater than 100 nm.

β₂ and β₄ of the nonlinear optical medium can implement desired values by the optical fiber constituted by core and cladding to combine selected so that the core and the cladding of the optical fiber have an appropriate refractive index difference value.

Here, when β₂>0 and β₄<0, frequency shift quantity Δω (i.e., wavelength shift quantity Δλ) of light generated by degeneration four wave mixing with respect to excitation light, and a frequency width δω (i.e., a spectral half-value width δλ) of generated light are each expressed by the following Expressions.

$$\begin{matrix}Δω = \sqrt{\frac{12 {β}_{2}}{\vert {β}_{4} \vert}} = \sqrt{\frac{12 {β}_{3} ( {ω}_{c} - {ω}_{0} )}{\vert {β}_{4} \vert}} & Expression ( 4 ) \\ Δλ = \frac{1}{A} \sqrt{\frac{12 {β}_{2}}{\vert {β}_{4} \vert}} = \frac{1}{A} \sqrt{\frac{12 {β}_{3} A ( {λ}_{0} - {λ}_{c} )}{\vert {β}_{4} \vert}} \\ A = \frac{2 π c}{{λ}_{0}^{2}} & Expression ( 5 ) \\ δω = \frac{24 γ {P}_{c}}{\vert {β}_{4} \vert {Δω}^{3}} & Expression ( 6 ) \\ δλ = \frac{24 γ {P}_{c}}{{A}^{4} \vert {β}_{4} \vert {Δλ}^{3}} & Expression ( 7 )\end{matrix}$$

In these Expressions, ω₀ denotes a zero dispersion frequency of the nonlinear optical medium, λ_{c} denotes the center wavelength of excitation light, λ₀ denotes a zero dispersion wavelength of the nonlinear optical medium, and β₃ is a first derivative of group velocity dispersion β₂ in the zero dispersion wavelength.

Expression (5) shows that the wavelength shift quantity Δλ, becomes larger by the coefficient than the change of the center wavelength λ_{c} of excitation light. That is, even if the change in the center wavelength λ_{c} of excitation light is very small, the shift quantity of the center wavelength of the signal light (or the idler light) becomes large. Expression (7) shows that, if a nonlinear optical medium with a small nonlinear coefficient γ and a large β₄ is used, signal light (or idler light) of a narrow spectral width δλ may be generated.

The description above is the principle of generation of four wave mixing (especially degeneration four wave mixing).

Next, a light source apparatus utilizing four wave mixing (a kind of optical parametric effects) produced by the optical fiber using a light source of a configuration disclosed in Optics Express Vol. 20, No. 19, pp. 21010-21018, Sep. 10, 2012 is described.

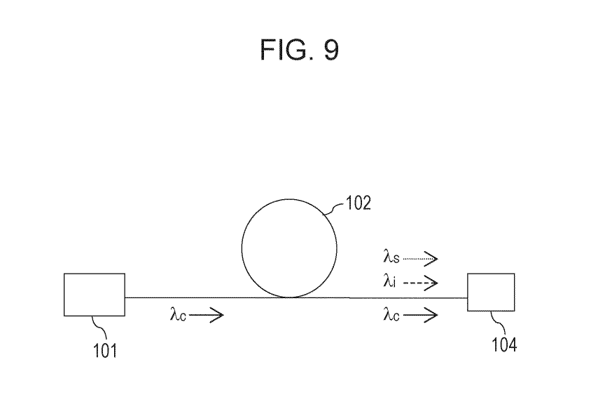

FIG. 9 is a schematic diagram of the light source apparatus of a configuration disclosed in Optics Express Vol. 20, No. 19, pp. 21010-21018, Sep. 10, 2012. The nonlinear optical medium is formed by one kind of fiber.

Excitation pulsed light with the center wavelength λ_{c} emitted from an excitation light source 101 enters into a nonlinear optical medium 102. Upon irradiation of the excitation pulsed light, signal light with the center wavelength λₛ different from that of the excitation pulsed light (<λ_{c}) and idler light with the center wavelength λᵢ different from that of the excitation pulsed light (>λ_{c}) are generated by the optical parametric gain of the nonlinear optical medium, and are emitted from a light emitting portion 104. In Optics Express Vol. 20, No. 19, pp. 21010-21018, Sep. 10, 2012, a subject is irradiated with the excitation pulsed light and the signal light, and light based on CARS is detected.

With the characteristics of the optical parametric gain that the nonlinear optical medium has, the center wavelength of the generated light changes greatly by the slight change of the center wavelength of excitation pulsed light. Therefore, when this phenomenon is used, the frequency difference between the two types of pulsed light to be emitted may be changed in a broadband. Two types of pulsed light output from the light source apparatus is not limited to those disclosed in Optics Express Vol. 20, No. 19, pp. 21010-21018, Sep. 10, 2012, but two types of light may be selected from among excitation pulsed light and two types of generated light.

In the configuration of FIG. 9, as described above, the peak intensity becomes low when the spectral line width of the generated light is to be narrowed, and spectral line width becomes large when the peak intensity is to be increased. This is understood from the fact that, in Expressions (1) and (3), when Pc is increased, the range that satisfies the phase matching conditions expands.

The light of a wide spectral line width includes light of various frequencies. Therefore, when a spectral line width of at least one of two types of pulsed light with which the subject is irradiated is large, a frequency difference component inconsistent with the molecular vibrational frequency of a molecule that is a measurement target between two types of pulsed light is generated. The frequency difference component inconsistent with the molecular vibrational frequency is included as noise in the Raman spectrum obtained from the subject and, therefore, the S/N ratio is reduced. Generally, the spectral line width necessary to measure the Raman spectrum is equal to or narrower than 1 nm.

The light source apparatus according to the present invention includes a first nonlinear optical medium having normal dispersion characteristics, and a second nonlinear optical medium with a zero dispersion wavelength different from that of the first nonlinear optical medium, and having normal dispersion characteristics. The first nonlinear optical medium and the second nonlinear optical medium are connected in series. That is, a bandwidth of the first optical parametric gain generated in the first nonlinear optical medium and a bandwidth of the second optical parametric gain generated in the second nonlinear optical medium connected in series are shifted from each other. Therefore, the bandwidth of the optical parametric gain generated in the two entire nonlinear optical media may be narrowed.

Four wave mixing when the first nonlinear optical medium and the second nonlinear optical medium having the zero dispersion wavelength different from that of the first nonlinear optical medium are connected in series is described in detail. In a configuration in which the first nonlinear optical medium and the second nonlinear optical medium are connected in series, light emitted from one of the first nonlinear optical medium and the second nonlinear optical medium enters the other of the first nonlinear optical medium and the second nonlinear optical medium. For example, the first nonlinear optical medium and the second nonlinear optical medium may be connected directly. Alternatively, the first nonlinear optical medium and the second nonlinear optical medium may be connected indirectly via a different medium.

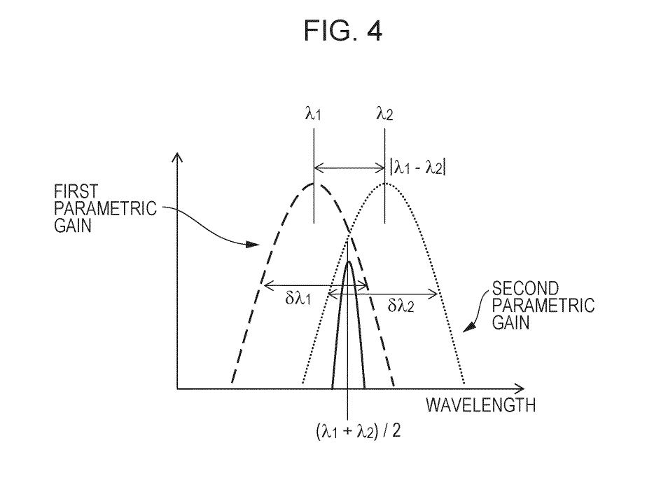

FIG. 4 illustrates optical parametric gains generated in the two nonlinear optical media connected in series and having different zero dispersion wavelengths. The first optical parametric gain generated in the first nonlinear optical medium upon incidence of excitation pulsed light of the center wavelength λ_{c}, i.e., first pulsed light, is illustrated by a dashed line, and the second optical parametric gain, generated in the second nonlinear optical medium upon incidence of excitation pulsed light of the center wavelength λ_{c}, i.e., second pulsed light, is illustrated by a dotted line. The center wavelength of the first pulsed light is referred to as λ₁ and the center wavelength of the second pulsed light is referred to as λ₂. Although only signal light is illustrated in FIG. 4, the same is applied to idler light.

Expression (5) shows that, when the center wavelength of excitation pulsed light is λ_{c}, if two nonlinear optical media are different in at least one of the zero dispersion wavelength, β₃ and β₄, the wavelength shift quantity of light generated in each nonlinear optical medium becomes different. Actually, however, since it is very difficult and not realistic to adjust β₃ and β₄ of the nonlinear optical medium to any value, two nonlinear optical media different in zero dispersion wavelengths are used.

A case in which two nonlinear optical media different in zero dispersion wavelengths are connected in series, and excitation pulsed light with the center wavelength λ_{c} is made to enter from the first non-linear optical medium side is considered. The bandwidth of the optical parametric gain generated in the two entire nonlinear optical media connected in series is expressed as a product of the first optical parametric gain and the second optical parametric gain by the excitation pulsed light of the center wavelength λ_{c}. In FIG. 4, the bandwidth of the optical parametric gain generated in the two entire nonlinear optical media by the excitation pulsed light of the center wavelength λ_{c} is illustrated by a solid line.

As is understood from FIG. 4, in the first generated light generated by the first nonlinear optical medium, only an overlapping area of the first optical parametric gain and the second optical parametric gain is amplified by the second nonlinear optical medium. Therefore, the spectral line width of the generated light after passing through the two nonlinear optical media becomes narrower corresponding to the width of the overlapping area of the first optical parametric gain and the second optical parametric gain. When the spectral line width of the generated light after passing through the two nonlinear optical media is set to be equal to or narrower than 1 nm that is suitable for the Raman measurement, it is desirable to arrange, in series, the two nonlinear optical media of which zero dispersion wavelengths differ by equal to or greater than 0.1 nm.

Hereinafter, the optical parametric gain illustrated in FIG. 4 by the solid line is referred to as a third optical parametric gain. Light generated by the third optical parametric gain, i.e., generated light obtained by passing through the first nonlinear optical medium and the second nonlinear optical medium is referred to as third generated light. The center wavelength of the third generated light can be approximated to (λ₁+λ₂)/2.

To narrow the spectral line width of the third generated light and to increase generation efficiency, it is desirable that the first nonlinear optical medium and the second nonlinear optical medium satisfy the range expressed by the following Expressions.

$$\frac{{δλ}_{1}}{2} < \vert {λ}_{1} - {λ}_{2} \vert < {δλ}_{1} and \frac{{δλ}_{2}}{2} < \vert {λ}_{1} - {λ}_{2} \vert < {δλ}_{2} \qquad Expression ( 8 )$$

In Expression (8), λ₁ is the center wavelength of the first optical parametric gain, and δλ₁ is the spectral half-value width of the first optical parametric gain expressed by Expression (8). λ₂ is the center wavelength of the second optical parametric gain, and δλ₂ is the spectral half-value width of the second optical parametric gain expressed by Expression (8).

In the second non-linear optical medium, the second generated light of the center wavelength λ₂ is generated upon incidence of excitation pulsed light of the center wavelength λ_{c} that has passed through the first nonlinear optical medium. The peak intensity of the second generated light is as small as about 1/10 of that of the third generated light. The second generated light is desirably cut using, for example, a band pass filter when being output from the light source apparatus, if necessary.

Hereinafter, embodiments of the light source apparatus and the information acquisition apparatus according to the present invention are described with reference to the drawings, but the present invention is not limited to the configurations and the like of the embodiments. Members denoted by the same reference numerals are the same or corresponding members throughout the drawings. Description of the details common to the embodiments may be omitted.

### First Embodiment

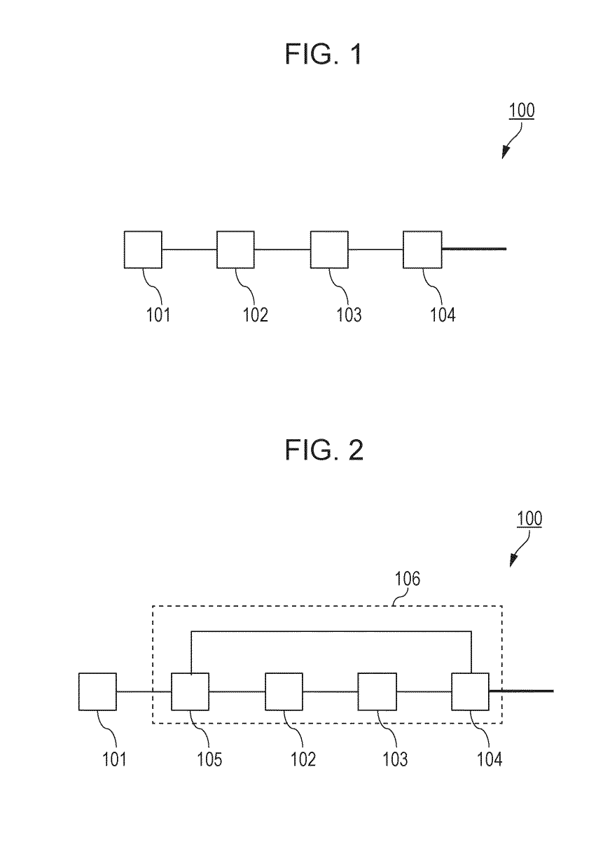

FIG. 1 is a schematic diagram of a light source apparatus 100 according to the present embodiment. The light source apparatus of FIG. 1 includes an excitation light source 101 that emits pulsed light, a first nonlinear optical medium 102, a second nonlinear optical medium 103, and a light emitting portion 104.

The excitation light source 101 may emit first pulsed light (i.e., excitation pulsed light) with variable center wavelength λ_{c}. The excitation light source 101 may suitably be, for example, a pulse laser that includes a wavelength filter in a laser resonator, and may change the wavelength in a gain band of a laser medium. The narrower the spectral width of the pulsed light incident on the nonlinear optical medium, the more efficiently four wave mixing occurs and, sufficient optical parametric gain may be obtained. Therefore, the spectral width of the excitation pulsed light emitted from the excitation light source 101 is desirably set to equal to or narrower than 1 nm.

Optical fiber with high nonlinear coefficient, such as photonic crystal fiber and tapered fiber, may be suitably used for the first nonlinear optical medium 102 and the second nonlinear optical medium 103.

Photonic crystal fiber is fiber provided with many holes (air holes) in the cladding of the optical fiber. The holes significantly reduce a refractive index of the cladding of the photonic crystal fiber compared with that of the core. Therefore, since an effectual core diameter (i.e., a mode field diameter) may be reduced, a great nonlinear effect may be obtained even if the fiber length is as short as several meters. Further, arbitrary wavelength dispersion characteristics may be obtained by adjusting the size and the pitch of the holes.

Tapered fiber is fiber of which clad diameter of optical fiber is narrowed, and may be manufactured by heating and extending normal optical fiber. When the clad diameter of the tapered fiber is reduced significantly to about several um, a great nonlinear effect may be obtained even if the fiber length is as short as several mm. Further, arbitrary wavelength dispersion characteristics may be obtained by adjusting the clad diameter and the length of the tapered fiber.

The used first nonlinear optical medium 102 and the second nonlinear optical medium 103 differ in zero dispersion wavelength and have normal dispersion characteristics in the center wavelength λ_{c} of pulsed light. The light emitting portion 104 may include a band pass filter that cuts light other than the light of the bandwidth to be emitted.

The excitation pulsed light emitted from the excitation light source 101 is guided to the first nonlinear optical medium 102 and the second nonlinear optical medium 103, and the third generated light with a narrow spectral line width is generated by the third optical parametric gain illustrated by the solid line in FIG. 4. With this configuration, the third generated light of which spectral width is narrower than those of the first generated light or the second generated light generated when excitation pulsed light enters only into the first nonlinear optical medium 102 or the second nonlinear optical medium 103 may be generated.

### Second Embodiment

Another embodiment of the light source apparatus according to the present invention is illustrated in FIG. 2. The present embodiment differs from the light source apparatus of the first embodiment in that a fiber optical parametric oscillator (FOPO) is provided.

A light source apparatus of FIG. 2 includes an excitation light source 101 that emits pulsed light, a multiplexer 105, a first nonlinear optical medium 102, a second nonlinear optical medium 103, and a brancher (i.e., a light emitting portion) 104. The multiplexer 105 and the brancher 104 are connected by a waveguide, and configure a resonator 106 that includes the first nonlinear optical medium 102 and the second nonlinear optical medium 103.

Since the first nonlinear optical medium 102 and the second nonlinear optical medium 103 are disposed in the resonator 106, first generated light generated in a first nonlinear optical medium repeatedly passes through the first and second nonlinear optical media, and carries out parametric oscillation each time of passing through the first and second nonlinear optical media. Thus, third pulsed light amplified by the parametric oscillation inside the resonator 106 is taken out of the resonator 106 via the brancher 104.

When a resonator 106 is provided, it is desirable to set a pulse rate of excitation pulsed light to an integer multiple of a free spectral range (FSR) of the resonator 106 in the wavelength of the first generated light. By satisfying this relationship, third pulsed light may be taken out as pulsed light with high peak intensity.

In the light source apparatus according to the present embodiment, peak intensity of the third pulsed light may be set to be higher than that of the first embodiment. Therefore, the light source apparatus according to the present embodiment may be suitably used for an information acquisition apparatus that requires pulsed light with high peak intensity.

### Third Embodiment

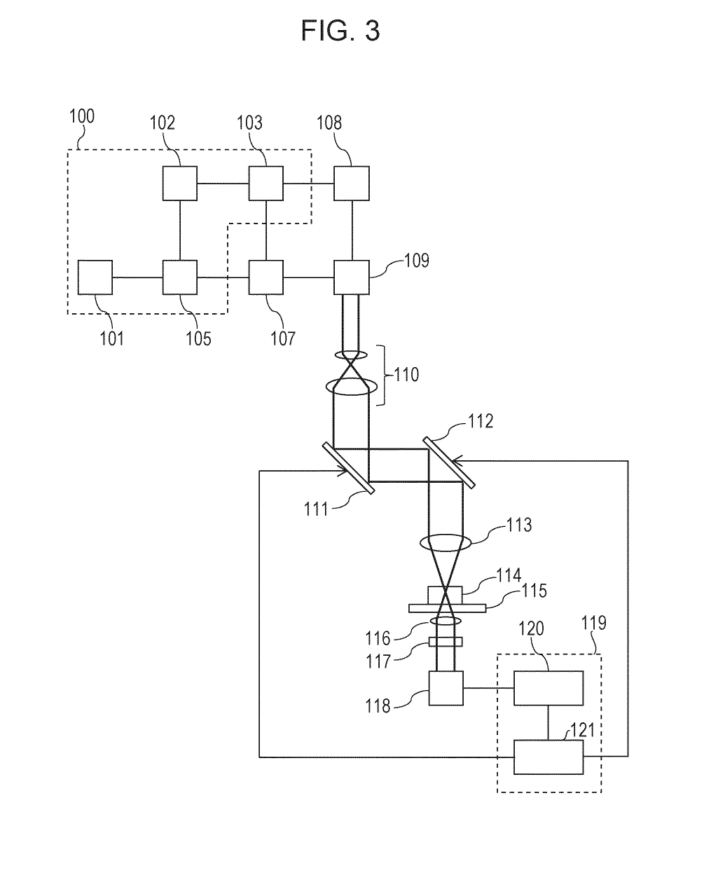

FIG. 3 is a schematic diagram illustrating an information acquisition apparatus according to the present embodiment. In the present embodiment, a microscope (i.e., an SRS microscope) that performs SRS imaging using the light source apparatus of the first embodiment is described as an exemplary apparatus.

SRS imaging is a technique to cause pump light and stokes light having different wavelengths to enter into a substance, and utilize a phenomenon of stimulated Raman scattering produced by interference of these two types of light so as to obtain molecular vibration imaging. Specifically, a subject is irradiated with pump light and stokes light that are synchronized with each other in a state in which intensity of the stokes light has been modulated. When a difference frequency between the pump light and the stokes light is consistent with a molecular vibrational frequency of molecules that constitute the subject, stimulated Raman scattering occurs, and the intensity-modulated stokes light is amplified. Depending on the intensity modulation of the stokes light, intensity of the pump light of which intensity has not modulated is also modulated. Therefore, molecular vibration imaging of the subject becomes possible by detecting an intensity modulation component by stimulated Raman scattering of the pump light via the subject. Further, by changing the center wavelength of the pulsed light and changing the difference frequency between the two types of pulsed light, it is possible to cause the difference frequency to be consistent with molecular vibrational frequencies of various molecule, and signals peculiar to a molecule group that constitutes the subject may be obtained.

Excitation pulsed light (i.e., first pulsed light) λ_{c} emitted by the excitation light source 101 is branched into two by the brancher 105, and the branched one of the light components is modulated by a light modulator 107 and used as the stokes light for the SRS microscope. The other of the light components is made to enter into the first nonlinear optical medium 102 and the second nonlinear optical medium 103 to generate signal light and idler light. Either the signal light or the idler light (the signal light in the present embodiment) is emitted via a band pass filter 108 as generated light (i.e., second pulsed light) λₛ.

The first nonlinear optical medium 102 and the second nonlinear optical medium 103 are different in zero dispersion wavelength satisfy the condition of β₂>0 and β₄≦0, and suitably use optical fiber with a high nonlinear coefficient. Generated light taken out of a band pass filter 305 is used as pump light for the SRS microscope.

The stokes light and the pump light are multiplexed by a multiplexer 109 with which light the subject is irradiated. An optical coupler, diffraction grating, prism, and the like may be used as the multiplexer 109 that multiplexes a plurality of types of pulsed light having different center wavelengths.

The multiplexed stokes light and pump light are condensed on a subject 114 placed on a stage 115 via a beam expander 110, an X scan mirror 111, a Y scan mirror 112, and an objective lens 113.

In the subject 114, in a micro region at the center of a condensing point of the objective lens 113, stimulated Raman scattering based on molecular vibration of the molecules occurs and, thereby, intensity of the pump light and the stokes light change. Since stimulated Raman scattering does not occur outside the micro region at the center of the condensing point, no change in intensity in the pump light and the stokes light is caused. The larger the NA of the objective lens 113, the smaller the spot size of light with which the subject 114 is irradiated becomes and, the smaller the size of the micro region in which stimulated Raman scattering occurs becomes.

The pump light of which intensity has been modulated by stimulated Raman scattering occurred in the micro region at the center of the condensing point passes through a condenser 116 and a band pass filter 117, enters into a light-receiving element 118 and is detected as an SRS signal, and then is obtained as an image signal by an information acquisition unit 119.

Generally, a Raman scattering cross-sectional area σ of a molecule is small, change in intensity of the pump light due to stimulated Raman scattering also becomes very small. Therefore, when detecting an SRS signal from the change in intensity of the pump light, the SRS signal may be buried in, for example, a noise component. In the present embodiment, intensity modulation of the pump light received and converted into an electrical signal by the light-receiving element 118 is detected using the information acquisition unit 119 provided with a synchronization detector 120 and a control unit 121 in synchronization with the modulation frequency of a light modulator, and molecular vibration imaging of the subject 114 is obtained. When the synchronously detected signal is amplified, the SRS signal may be detected with high sensitivity.

A lock in amplifier, an FFT analyzer, and the like may be used as the synchronization detector 120. Among these, an FFT analyzer may detect the SRS signal at a high speed compared with a lock in amplifier. In FIG. 3, the synchronization detector 120 and the control unit 121 are provided separately in the information acquisition unit 119, but these components may be integrated alternatively. An example in which the synchronization detector 120 and the control unit 121 are integrated includes a computer provided with a CPU used as the control unit 121 incorporates an application having a synchronizing detection function.

When the X scan mirror 111 is driven, the condensing point may scan the inside of the subject 114 in the X direction and, when the Y scan mirror 112 is driven, the condensing point may scan the inside of the subject 114 in the Y direction perpendicular to the X direction. Therefore, when the condensing point is made to scan on the subject 114 by the X scan mirror 111 and the Y scan mirror 112, a two-dimensional image may be obtained.

Further, a three-dimensional image of the subject 114 may be obtained by, after one event of the two-dimensional scanning is completed, moving a stage 115 to shift the condensing point in an optical axis direction by a predetermined distance, and repeating the same two-dimensional scanning.

Further, after one event of the two-dimensional scanning or the three-dimensional scanning is completed, by changing the center wavelength of the excitation light source 101, the difference frequency between the wavelengths of the pump light and the stokes light may be changed, so that the difference frequency may be consistent with the molecular vibrational frequencies of those of various molecules included in the subject 114. Thus, a two-dimensional or a three-dimensional molecular vibration image may be obtained.

A pulse width of the pulsed light emitted from the light source apparatus used for the SRS microscope according to the present embodiment is desirably equal to or narrower than 1 ns, and more desirably equal to or narrower than 100 ps. This is because, the narrower the pulse width of the pulsed light, the greater the peak intensity of the pulsed light becomes and, therefore, existence of a nonlinear effect produced at the subject 114 may be detected with high accuracy. Further, the pulse rate of the pulsed light emitted from the excitation light source 101 is desirably equal to or greater than 1 MHz and equal to or less than 1 GHz. The pulse rate equal to or greater than 1 MHz is desirable from the restriction of a measuring speed actually required as the SRS microscope and the pulse rate equal to or less than 1 GHz is desirable from the restriction of thermal destruction caused in the subject 114.

Since the SRS microscope is used suitably for the observation of body tissues, each type of pulsed light emitted from the light source apparatus desirably has a wavelength that is less easily reflected on, absorbed into, and scattered on a living body, and easily passes through a living body. Therefore, the center wavelength of each pulsed light emitted from the light source apparatus is desirably equal to or greater than 300 nm and equal to or less than 1500 nm, and more desirably equal to or greater than 700 nm and equal to or less than 1300 nm. For example, mode synchronous Yb (ytterbium) doped fiber laser is suitable for the excitation light source 101.

As described above, the SRS microscope according to the present embodiment may narrow the spectral line width of the pump light. Therefore, the S/N ratio of Raman spectrum obtained from the subject 114 can be improved, and a clear image with a large S/N ratio may be obtained.

Since the light source apparatus is reduced in size and cost compared with related art SRS microscopes, the entire SRS microscopes may be reduced in size and cost.

In the present embodiment, an SRS microscope is exemplified as an information acquisition apparatus that obtains information about a subject by emitting two types of pulsed light at the subject, and detecting at least one of light reflected on the subject, light passing through the subject, and light emitted from the subject. However, the SRS microscope is not restrictive and the light source apparatus of the first or second embodiment, as well as the present embodiment, may be applied to the information acquisition apparatus that obtains various types of spectral information, such as a CARS microscope, a fluorescence microscope, and an endoscope.

When the light source apparatus according to the present invention is used, even if the peak intensity is increased, the spectral line width of pulsed light generated in the nonlinear optical medium may be narrowed. Further, the information acquisition apparatus provided with the light source apparatus according to the present invention may reduce noise included in Raman spectrum obtained from the subject and, therefore, the S/N ratio may be improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-118104, filed Jun. 6, 2014 which is hereby incorporated by reference herein in its entirety.

What is claimed is:

1. A light source apparatus, comprising:
a light source configured to emit first pulsed light;
a first nonlinear optical medium configured to generate a first optical parametric gain upon incidence of the first pulsed light; and
a second nonlinear optical medium configured to generate a second optical parametric gain different from the first optical parametric gain upon incidence of the first pulsed light,
wherein
the first nonlinear optical medium and the second nonlinear optical medium have normal dispersion characteristics in the center wavelength of the first pulsed light,
zero dispersion wavelength of the first nonlinear optical medium is different from that of the second nonlinear optical medium, and
the first nonlinear optical medium and the second nonlinear optical medium are arranged in series.

2. The light source apparatus according to claim 1, wherein the difference between the zero dispersion wavelength of the first nonlinear optical medium and the zero dispersion wavelength of the second nonlinear optical medium is equal to or greater than 0.1 nm.

3. The light source apparatus according to claim 1, wherein, if the center wavelength of the first optical parametric gain is λ₁, a spectral half-value width of the first optical parametric gain is δλ₁, the center wavelength of the second optical parametric gain is λ₂, and a spectral half-value width of the second optical parametric gain is δλ₂, the first nonlinear optical medium and the second nonlinear optical medium satisfy the following Expressions:
$$\frac{{δλ}_{1}}{2} < \vert {λ}_{1} - {λ}_{2} \vert < {δλ}_{1} and \frac{{δλ}_{2}}{2} < \vert {λ}_{1} - {λ}_{2} \vert < {δλ}_{2} .$$

4. The light source apparatus according to claim 1, wherein the center wavelength of the first pulsed light is variable.

5. The light source apparatus according to claim 1, wherein the first and second nonlinear optical media are disposed in a resonator that oscillates the second pulsed light.

6. The light source apparatus according to claim 5, wherein a pulse rate of the first pulsed light is an integer multiple of a free spectral interval of the resonator in the center wavelength of pulsed light generated in the first nonlinear optical medium upon incidence of the first pulsed light.

7. The light source apparatus according to claim 1, wherein at least one of the first nonlinear optical medium and the second nonlinear optical medium includes a photonic crystal fiber or a tapered fiber.

8. The light source apparatus according to claim 1, wherein a spectral width of the first pulsed light is equal to or narrower than 1 nm.

9. An information acquisition apparatus that irradiates a subject with two types of pulsed light having different center wavelengths, detects at least one of light reflected from the subject, light that passes through the subject, and light emitted from the subject, and obtains information about the subject, the apparatus comprising:
a light source apparatus configured to emit the two types of pulsed light having different center wavelengths; and
a light-receiving element configured to receive the at least one of light reflected from the subject, light that passes through the subject, and light emitted from the subject,
wherein the light source apparatus is the light source apparatus according to claim 1.

10. The information acquisition apparatus according to claim 9, wherein pulse rates of the two types of pulsed light having different center wavelengths are both equal to or greater than 1 MHz and equal to or smaller than 1 GHz.

11. The information acquisition apparatus according to claim 9, wherein spectral widths of the two types of pulsed light having different center wavelengths are both equal to or smaller than 1 nm.

12. The information acquisition apparatus according to claim 9, further comprising an information acquisition unit configured to obtain light received at a light-receiving element as an electrical signal, wherein the information acquisition unit includes a synchronization detector that obtains a signal in synchronization with modulation of light received at the light-receiving element.

13. The light source apparatus according to claim 1, wherein the first nonlinear optical medium and the second nonlinear optical medium are arranged in series to form a resonator.

14. A light source apparatus, comprising:
a light source configured to emit first light;
a first nonlinear optical medium into which the first light enters; and
a second nonlinear optical medium into which light emitted from the first nonlinear optical medium enters,
wherein
both the first nonlinear optical medium and the second nonlinear optical medium have normal dispersion characteristics in the center wavelength of the first light, and
a zero dispersion wavelength of the first nonlinear optical medium differs from a zero dispersion wavelength of the second nonlinear optical medium.

15. A light source apparatus, comprising:
a light source configured to emit first light;
a first nonlinear optical medium into which the first light enters; and
a second nonlinear optical medium into which light emitted from the first nonlinear optical medium enters,
wherein
both the first nonlinear optical medium and the second nonlinear optical medium have normal dispersion characteristics in the center wavelength of the first light, and
a first parametric gain of the first nonlinear optical medium generated when the first light enters the first nonlinear optical medium differs from a second parametric gain of the second nonlinear optical medium generated when the first light enters the second nonlinear optical medium.
